(19) United States
(12) Patent Application Publication
(10) Pub. No.: US 2016/0068214 A1
(43) Pub. Date: Mar. 10, 2016

(54) ILLUMINATED CLOTHING APPARATUS AND METHOD

(71) Applicants: Heather Wenni TANG, Aurora (CA); Kabir Mangesh NADKARNI, Edmonton (CA); Qiwen ZHU, North York (CA); Yaning TAN, Scarborough (CA); Mike Meichang WANG, Richmond Hill (CA); Joohee LEE, Winnipeg (CA); Anand MATHEW, Waterloo (CA); Amanda Marla MATTHEWS, Edmonton (CA)

(72) Inventors: Heather Wenni TANG, Aurora (CA); Kabir Mangesh NADKARNI, Edmonton (CA); Qiwen ZHU, North York (CA); Yaning TAN, Scarborough (CA); Mike Meichang WANG, Richmond Hill (CA); Joohee LEE, Winnipeg (CA); Anand MATHEW, Waterloo (CA); Amanda Marie MATTHEWS, Edmonton (CA)

(21) Appl. No.: 14/480,435

(22) Filed: Sep. 8, 2014

(51) Int. Cl. B62J 6/00; F21L 13/00; F21L 4/00; B62J 6/04; F21V 23/04; A41D 19/00; A41D 3/00; B62J 6/16; F21V 33/00; F21V 23/00

(52) U.S. Cl. CPC B62J 6/003; F21V 33/0008; F21L 13/00; F21L 4/00; F21V 23/003; F21V 23/0464; A41D 19/00; A41D 3/00; B62J 6/005; B62J 6/16; B62J 6/04; F21W 2111/10

(57) ABSTRACT

Clothing apparatus may include a jacket and gloves. The clothing apparatus includes illuminating elements, a power source, a controller, and hand operated switches. The gloves are in signaling communication with the controller, such as may permit the operator to cause signaling functions to occur by use of the hands without releasing, for example, the handle bars of a bicycle., and without having to fumble with external manual switches. The power and control units may be removable and rechargeable. The jacket may be water-resistant or water-proof, and may include a hood. The apparatus may include a photo-sensitive element and running lights such as may operate automatically as dusk falls.

### FIELD OF INVENTION

This description relates to the field of illuminated clothing apparatus.

### BACKGROUND OF THE INVENTION

A description of known references pertaining to garments or apparel, or clothing, having illumination elements is provided in U.S. Pat. No. 5,690,411 of Jackman at col. 1, line 16 to col. 2, line 14, as follows:

“There have been and are many items of equipment and apparel intended for use by persons undertaking activities in areas that they must share with motorized vehicles, so that these persons will be seen by motorists . . . . Today, many of these persons wear bright colored or reflective clothing, in order to be visible to oncoming motorists. Furthermore, there have been and are garments equipped with means of illumination and lights that are portable or securable to an article of clothing.”

“U.S. Pat. No. 5,070,436, issued to Alexander et al Dec. 3, 1991, discloses a signal vest. Alexander et al is provided in front and back with flashable lights, provided solely as visibility means. The overall circuit in Alexander et al is divided into two separate sub-circuits, to assure the operation of some of the lights should one of these sub-circuits fail to operate. U.S. Pat. No. 4,328,533, issued to Paredes May 5, 1982, discloses an illuminated safety harness. Like Alexander et al, lights in Paredes are provided solely as extended visibility means. U.S. Pat. No. 5,488,361, issued to Perry Jan. 30, 1996, discloses a navigation lights device for personal watercraft. The lights in Perry enable observers to navigate around a user of Perry. These lights also indicate the position and immediate heading of the user of Perry.”

“Also among the related prior art: U.S. Pat. No. 5,307,251, issued to Shaffer Apr. 26, 1994, discloses a pedestrian crossing safety device, intended to arrest the movement of traffic. U.S. Pat. No. 4,709,436, issued to Branson Nov. 24, 1987, discloses an article of clothing having an illuminated display sign on the backside thereof. U.S. Pat. No. 4,480,293, issued to Wells Oct. 30, 1984, discloses a lighted sweatshirt. U.S. Pat. No. 5,113,325, issued to Elsenbrawn May 12, 1992, discloses a light assembly kit for illuminating an article of clothing. U.S. Pat. No. 5,278,734, issued to Ferber Jan. 11, 1994, discloses light illuminating assemblies for wearing apparel with light element securement means. U.S. Pat. No. Des. 259,146, issued to Carr, Jr. May 12, 1981, discloses a combined vest and blinker lights. U.S. Pat. No. Des. 277,808, issued to Nichols Mar. 5, 1985, discloses a combined florescent and reflecting safety vest. U.S. Pat. No. 4,412,205, issued to Von Kemencsky Oct. 25, 1983, discloses a switching construction responsive to motions of a wearer. U.S. Pat. No. 5,424,922 issued to Wise Jun. 13, 1995, discloses fiber optic apparel and safety gear.”

“An Interact search for “reflective or illuminated garments.” discovered several Traffic Vests™, provided with PVC reflective tape. These items are offered for purchase by AGO Industries, Inc. Root International, Inc. sells a luminous vest and a luminous belt. Bike Nashbar sells the Nathan Reflective Biking Vest™. Nashbar also sells the SL-20 Flashing Light™, Model 340C Yellow Clip Light™, and Model 300C Red Clip Light™”

“With the exception of Perry, the foregoing references are intended for use by persons undertaking activities in areas that they must share with motor vehicles. Yet, none of these references enables users to communicate their intention to commence, continue, or resume forward motion, to turn or bear to the right or left, to cross the roadway, or to stop.”

A further description of references is given in U.S. Pat. No. 6,538,567 of Stewart at col. 1, line 13 to col. 2, line 18, as follows:

“Turn signals on articles of apparel have long been the subject of inventor's endeavors, but to date, none have been particularly satisfactory.”

“An early attempt is seen in U.S. Pat. No. 1,209,059, issued Dec. 19, 1916, to Smith. A bare bulb, electrically connected to a battery, is attached to the sleeve of a driver, so that when the driver's arm is out of the window making the motions of a turn signal, the light will move with the arm and be visible to other motorists. Japanese Patent No. JP2265101, issued Oct. 29, 1990 to Hitoshi et al. discloses a jacket with a printed circuit board attached in the middle of its back. A matrix of light emitting diodes (LEDs) are mounted on the printed circuit board which is operationally connected with a motorcycle power source via a programmable operating system. A manipulated graphic with or without text can be displayed on the printed circuit board. The disclosure is very broad with few details, but apparently, when used as a turn signal, a large arrow is formed across the entire board by lighted LEDs, when a turn signal switch is activated by the biker, the arrow pointing in the direction of the turn. While the patentees state that the “turn signal” is activated by a “blinker,” it is not clear whether or not the arrow itself flashes on and off. Other displays, such as personal messages, are also programmed into the operating system. The system is expensive, requires separate attachment to the jacket, and the turn signal indication is not the type to which United States drivers are accustomed, opening the possibility that rather than being a clear notification of a turn, it could actually confuse other drivers.”

“Warning lights, including turn signals, have been placed on motorcycle helmets in U.S. Pat. Nos. 4,559,516, issued Dec. 17, 1985 to Schott et al., U.S. Pat. No. 5,207,500, issued May 4, 1993 to Rios et al., and 6,097,287, issued Aug. 1, 2000 to Lu. The helmet of Schott et al. is self-contained with the battery, switches, circuitry, and lights built-in, a complicated combination, which is expensive to manufacture and which adds to the weight of the helmet. The turn signal switches are inertia switches operable by movements of the cyclist's head, a system prone to accidental actuation, for a motorcyclist's head is constantly moving. Rios et al. include turn signals, a brake light, a tail light, and a head light in their helmet design, making for a large and heavy combination. All of the lights of Rios et al. are powered and actuated by the motorcycle's electrical system. While a multi-lighted helmet is more easily seen by other motorists than one without lights, the light array disclosed by Rios et al. must present a confusing display. The cyclist's head is constantly rotating, thereby constantly changing the position of the left and right turn lights relative to the bike body, which leaves following drivers to wonder what, if anything, is being indicated. Lu adds to the conventional helmet only a brake light, inductively coupled to the brake system of the motorcycle. No indications of turns are involved.”

“Safety lights have also been placed on other wearing apparel, to be worn by policemen, joggers, runners, bicyclists, etc., to warn motorists or others in the vicinity of their presence. See U.S. Pat. Nos. 3,153,745; 5,070,436; 5,488,361; and 5,690,411. Only the last, issued Nov. 25, 1997, to Jackman includes manually actuated “turn signals” incorporated into a jogger's vest. They are powered by batteries carried by the wearer, adding to the garment's weight and complexity.”

“Many other lighted apparel have been patented, most for decorative or entertainment purposes. See, for example, U.S. Pat. Nos. 4,602,191; 4,709,307; 5,113,325; 5,278,734; and 5,613,756. They are not germaine to the instant invention.”

### SUMMARY OF INVENTION

The following summary may introduce the reader to the more detailed discussion to follow. The summary is not intended to, and does not, limit or define the claims.

In an aspect of the invention there is an illuminated clothing apparatus. It has a body-worn member, and at least a first hand-wear member. The body-worn member has a dorsal portion worn across the wearer's back. The dorsal portion has an illumination array, such as may be visible from behind. The first hand-wear member has at least a first control signal input interface; control circuitry; and a power source connection. The power source connection, the control circuitry, the first signal input interface and the illumination array are co-operatively mounted; and, as worn in operation. At least the first signal input interface of first hand-wear element is (or are, as may be) operable to control a plurality of functions of the illumination array.

In a feature of that aspect of the invention, the power source connection is connected to a power supply chosen from the set of power supplies consisting of: (a) a motion driven generator; (b) a bicycle mounted battery; (c) a pocket-carried battery pack; (d) a ventrally mounted battery; and (e) a dorsally mounted battery. In another feature, the hand wear element is connected to the body worn element by a hard-wired connection. In still another feature, the body-worn element includes sleeves, and at least one of the sleeves includes circuitry by which, in use, the first hand wear element is connected to at least one of the control circuitry, the power source connection, and the illumination array. In another feature, the illumination array includes at least a left turning display and a right turning display, and the plurality of functions includes at least a function for indication a left turn and another function for indicating a right turn. In a further feature, the illuminating apparatus includes any combination of at least three of: (a) a left turn signal display; (b) a right turn signal display; (c) a braking display; (d) a body mounted running light; and (e) an mounted running light. In still a further feature, the apparatus includes the first hand-wear member and a second hand wear member, the second hand-wear member having a second control signal input interface. In a still further feature, the body-worn member is a jacket having sleeves. In another further feature the body-worn member is a rain jacket.

In another feature of that aspect of the invention, the first hand-wear member is a glove, and the apparatus includes a second hand-wear member, the second hand-wear member being a mating glove of opposite handedness. In another feature, the first control signal input interface includes at least one of (a) a squeezable pressure switch; and (b) a contact switch. In another feature, the illuminating array includes at least one running light. In still another feature, the apparatus includes a light sensor, the light sensor being operatively connected to at least a first member of the illuminating array. In yet a further feature, the illuminating array includes at least one running light and the light sensor is connected to cause that running light to illuminate when dusk falls.

In another feature, the body-worn member includes a controller accommodation and a controller disconnect. In a further feature, the clothing includes the first hand wear member and a second hand-wear member, the first and second hand-wear members being first and second gloves of a pair of gloves, the first and second hand-wear members having at least first and second control signal input interfaces, the control signal input interfaces being operable to initiate a plurality of functions of the illuminating array. In still another feature, the-body worn member is a jacket having first and second sleeves, the jacket being a rain protector and having a hood. The hand-wear includes the first hand wear member and a second hand-wear member. The first and second hand-wear members define a pair of gloves. The first hand-wear member has at least the first control signal input interface. The second hand-wear member has at least a second control signal input interface. The gloves have cuffs for co-operation with the sleeves of the jacket. The gloves and the sleeves having co-operable releasable electrical connections by which the first and second control input interfaces are connected to the control circuitry.

In another aspect of the invention there is a method of operating any apparatus according to any combination of the features above, whether that operation includes intermittent flashing operation or otherwise. The operation includes hand motion while not letting go of a bicycle handle, and may include passive operation initiated by a photo-sensitive switch as darkness falls.

### BRIEF DESCRIPTION OF THE ILLUSTRATIONS

These and other features and aspects of the invention may be explained and understood with the aid of the accompanying illustrations, in which:

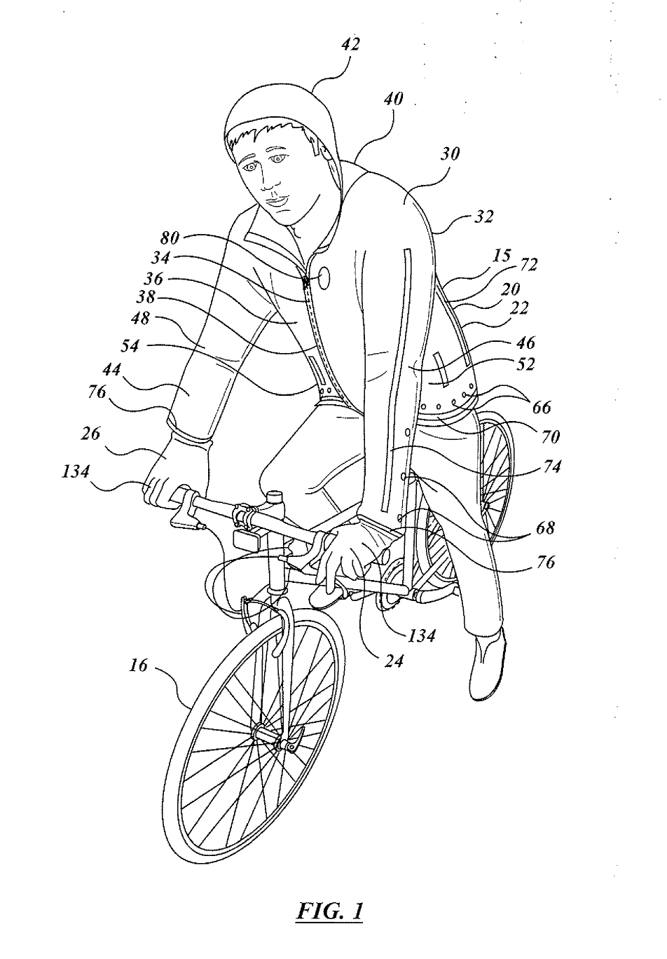

FIG. 1 shows a general arrangement view of a cyclist wearing clothing according to an aspect of the principles and features described herein, viewed from in front and to the left;

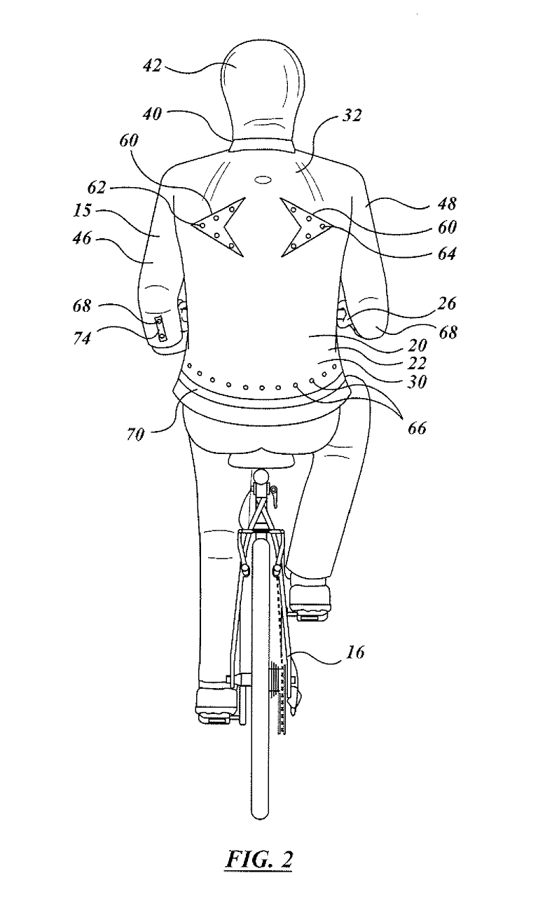

FIG. 2 is a view of the cyclist of FIG. 1 as seen from behind;

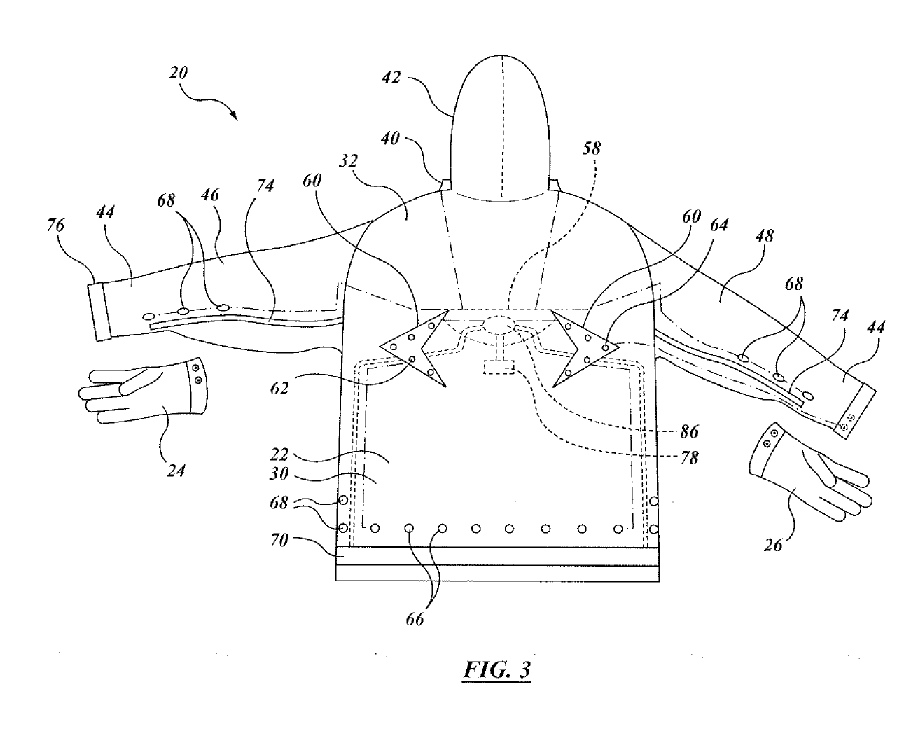

FIG. 3 is a rear view of clothing of the cyclist of FIGS. 1 and 2 including a body-wear garment and hand-wear garments;

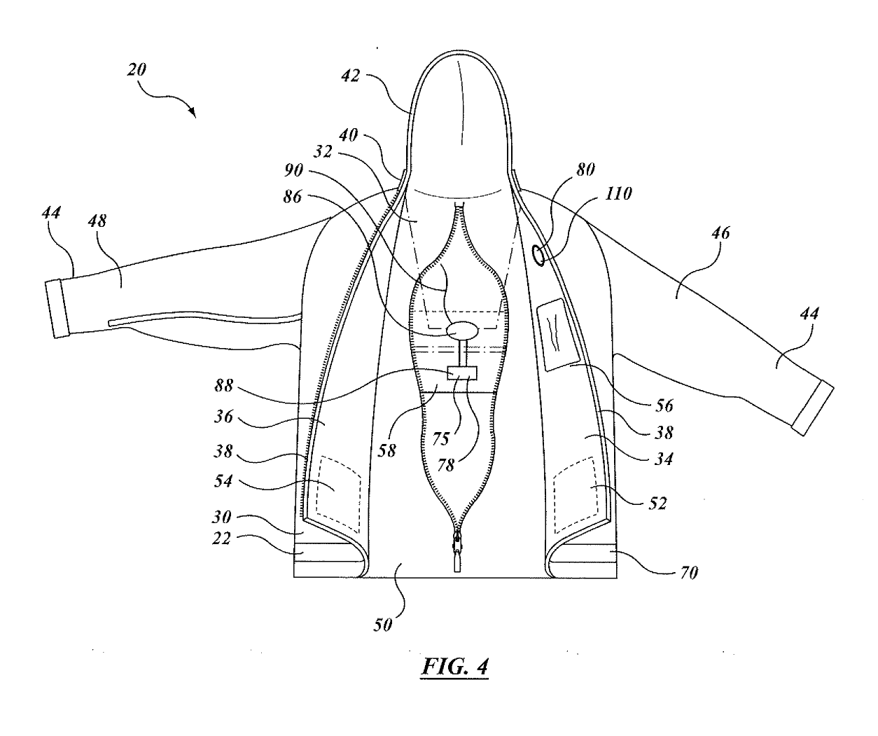

FIG. 4 is a front view of the body-wear garment of FIG. 3, with zipper undone and vest portions opened to reveal internal details;

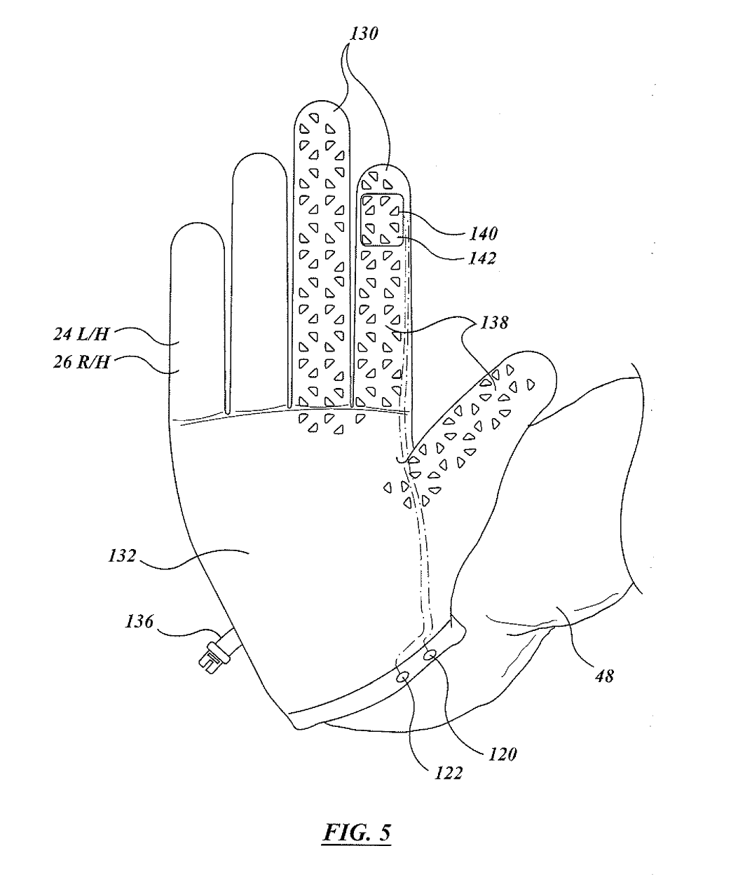

FIG. 5 is a palm-view of an embodiment of glove of the hand-wear of FIG. 3, with fingers extended;

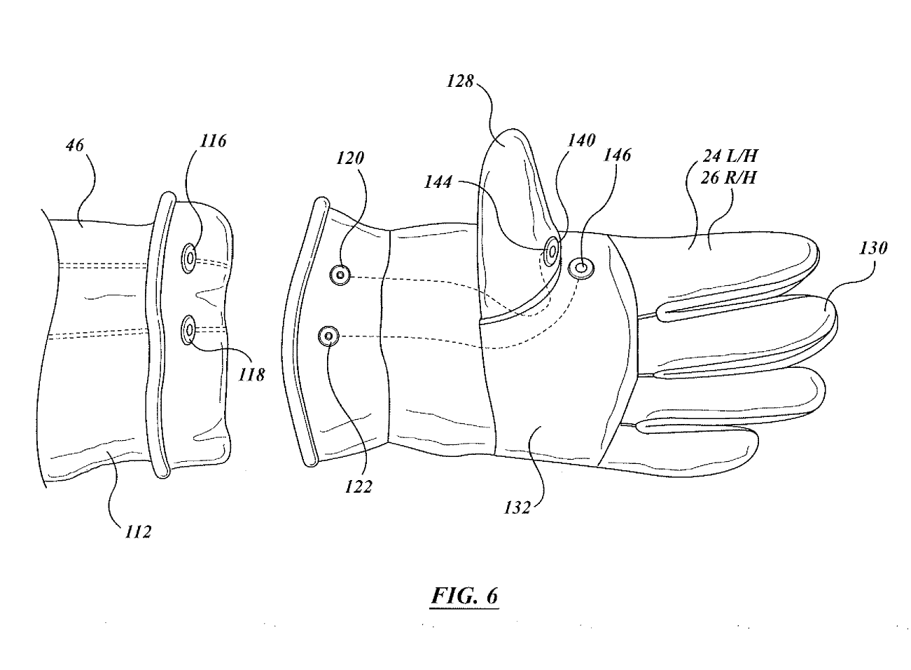

FIG. 6 is a front view of another embodiment of glove to that of FIG. 5, and an associated sleeve cuff of the body wear garment of FIG. 3, with the sleeve cuff partially turned back to reveal internal details;

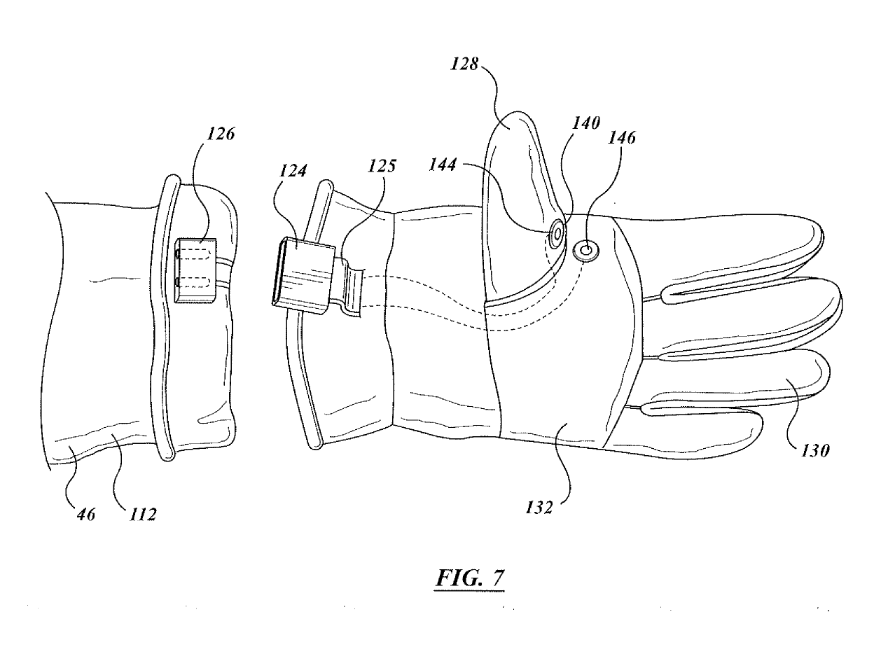

FIG. 7 is a front view of an alternate glove and cuff arrangement to that of FIG. 6 showing an alternate embodiment of connection; and

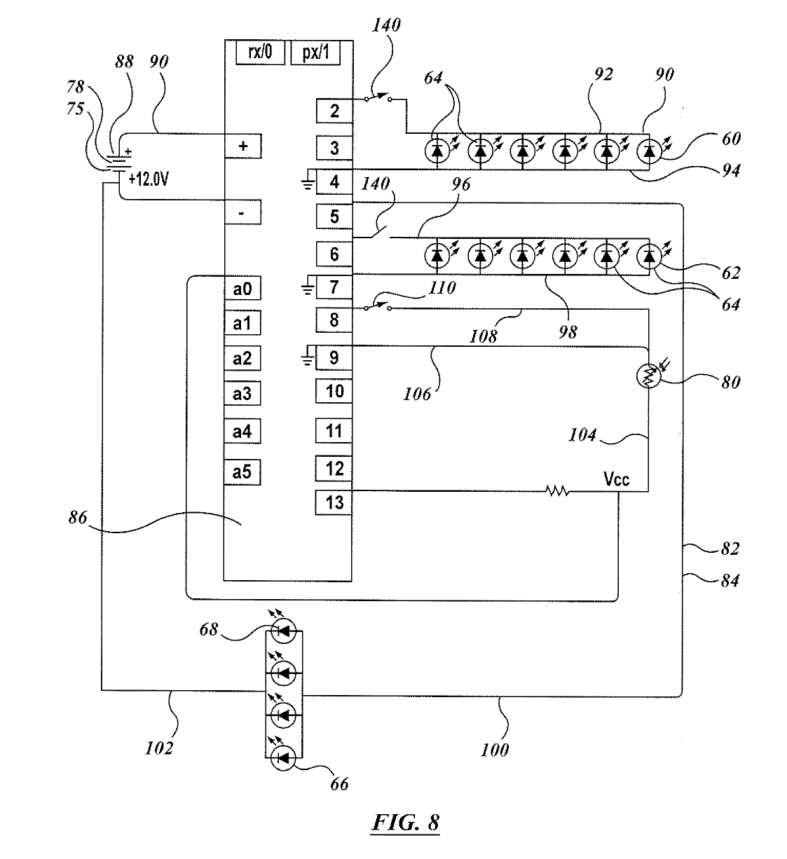

FIG. 8 is a simple wiring schematic for apparatus such as employed in the clothing of FIG. 2.

### DETAILED DESCRIPTION

The description that follows, and the embodiments described therein, are provided by way of illustration of an example, or examples, of particular embodiments incorporating one or more of the principles, aspects and features of the invention. These examples are provided for the purposes of explanation, and not of limitation, of those principles, aspects and features. In the description, like parts are marked throughout the specification and the drawings with the same respective reference numerals. The drawings may be taken as being to scale, or generally proportionate, unless indicated otherwise.

The scope of the invention herein is defined by the claims. Though the claims are supported by the description, they are not limited to any particular example or embodiment. Other than as indicated in the claims themselves, the claims are not limited to apparatus or processes having all of the features of any one apparatus or process described below, or to features common to multiple or all of the apparatus described below. It is possible that an apparatus, feature, or process described below is not an embodiment of any claimed invention.

The terminology used in this specification is thought to be consistent with the customary and ordinary meanings of those terms as they would be understood by a person of ordinary skill in the art in North America. The Applicant expressly excludes all interpretations of terminology that are inconsistent with this specification, and, in particular, expressly excludes interpretation of the claims or the language used in this specification such as may be made in the USPTO, or in any other Patent Office, other than those interpretations for which express support can be demonstrated in this specification or in objective evidence of record, demonstrating how the terms are used and understood by persons of ordinary skill in the art generally, or by way of expert evidence of a person or persons of experience in the art.

The commonly used engineering terms “proud”, “flush” and “shy” may be used herein to denote items that, respectively, protrude beyond an adjacent element, are level with an adjacent element, or do not extend as far as an adjacent element, the terms corresponding conceptually to the conditions of “greater than”, “equal to” and “less than”.

In this discussion it may be helpful to make reference to a frame of reference. By the nature of the clothing described herein being intended for use while the wearer is in motion, the frame of reference is that of a body generally—forward being generally the front or direction of motion, rearward being the direction facing backward toward over-taking traffic, left and right, up and down being as generally understood while riding a bicycle, for example.

Considering FIG. 1, a cyclist is shown seated on a bicycle. The cyclist has a clothing apparatus, indicated generally as 20. The clothing apparatus, or apparel, or however it may be termed, includes a body-worn member, or body wear, or garment, 22, and a first hand-wear member 24. It may also typically include a second hand-wear member 26.

Body-worn member, or garment, 22 may have the form of a jacket 30. Jacket 30 may have a main body with a dorsal portion 32, and left and right hand ventral portions 34, 36, such as may mate at a zipper 38. Jacket 30 may also have a collar, 40, and a hood 42. In some embodiments hood 42 may be foldable, such that it may be rolled up and stored within collar 40. Further, jacket 30 may have left and right hand sleeves, 46, 48. Which terminate at respective cuffs 44. In another embodiment, the hood itself defines a pouch into which the entire jacket may be rolled-up, or folded, as for storage. The package may have a strap, or elastic belt, or clip by which it may be worn at the rider's waist, or put in a back-pack.

Jacket 30 may be a rain jacket, and may be water-resistant or water-proof. Jacket 30 may have a lining 50. Jacket 30 may have left and right hand pockets 52, 54, and may have an internal right or left hand vest pocket 56. It may also have, or may alternatively have, a dorsal compartment, such as may be a zipper-closed or Velcro-closed compartment or pouch 58.

Looking at garment 22 externally, as from behind, the shoulder portions may have left hand and right hand illuminating elements 60, 62, respectively, such as may be lit up when the rider wishes to indicate an impending left- or right-hand turn. Illuminating elements 60, 62 may have the form of an array, such as an arrow, of a plurality of lighting elements such as may light all at once, or may light sequentially in progression in the direction of the arrow. Lighting elements 64 may be LED elements, and may typically be red, although another colour such as yellow might be chosen in another embodiment.

Additionally, garment 22 may have running light elements such as vertically along the wearer's side or horizontally along a waist band, as at 66, or on the underside, or rear side, of the arms between the elbows and the sleeve cuffs, as at 68. These running lights may be LED elements, and may have a white or yellow colour. In all cases, whether signal elements 64 or running light elements 66, when emitting light each of the LED elements, or all of them, may do so in a flashing manner such as may be more prone to attract attention, or to conserve energy, or both. The distinction is made between running lights and signalling lights. The term running light applies lights whose operation is not for the purpose of signalling, but for the purpose of steady state illumination, whether steady or flashing, merely to show the presence of the person or object, even if it is not moving. It is in that sense a passive light, and may be white or yellow.

In another embodiment, jacket 30 may additionally have reflective bands, such as at the waist at 70, along the sides of the body as at 72, along the line of the arm from shoulder to cuff as at 74, or at the cuff as at 76, or any combination thereof. Jacket 30 may also have a light sensor, 80, such as may be connected to cause one or more of the running light elements to operate when external ambient lighting goes dim, as at dusk, whether the running lights have been manually activated by the rider or not. Sensor 80 may be mounted on a chest portion of jacket 30, perhaps near collar 40, facing outwardly to sense ambient light.

The apparatus may have a power supply 78, and a power supply connection, or wiring harness or circuitry, as indicated generally at 82, and control circuitry as indicated at 84. The control circuitry may include a programmable computer, or micro-computer, 86, such as a Lilypad Arduino (t.m.) microcontroller, a well-known and conveniently available type of open-source controller that is waterproof and shatter resistant.

Power may be supplied by a bicycle generator such as may run against one of the wheels, or by the turning of a wheel hub and such as may have a lanyard or tether connection or plug suitable for mating with the connection of the clothing. In such case the generator and clothing may be sold as a kit. Alternatively the clothing may be sold with an adapter connection suitable for use with an existing generator set.

Alternatively, as shown in the embodiment herein, power may be supplied from batteries 75. Batteries 75 may be rechargeable batteries. Batteries 75 may be mounted in pouch 58 with control circuitry 84. Alternatively, the batteries may be mounted in a battery pack, 88 such as may be carried in any one of pockets 52, 54 or 56. Battery pack 88 may be part of a package that includes programmable computer, or micro-controller, 86. The package of batteries and controller may be removable from jacket 30, as by a single quick-disconnect plug connection e.g., as when inside and wishing to recharge.

However the power may be supplied, electrical leads or connections 90, which may be a quick disconnect connections, run from power supply 78 to supply power to the control circuitry. Part of all of those leads or connections may be sewn into, or immediately adjacent to, a seam or seams of jacket 30, in the body or torso portion and in the sleeves, as may be, and may include electrically conductive thread. The electrically conductive thread may be sewn in multiple strands. Similarly, leads or connections or strands supply power to the LED lighting elements, as at 92, 94 (l/h); 96, 98 (r/h); 100, 102 (running lights) and other leads such as 104, 106, 108 connect light sensor 80 to the control circuitry. Lead line 108 may connect a manual running light switch 110 to operate running lights 66, 68 independently of photo-sensitive switch 80. Further electrical leads, 112, 114 may be sewn into the seams of the respective sleeve, or sleeves, left or right as may be, to extend from the control circuitry to the cuffs 44 of sleeves 46, 48 at which they may have respective terminal connections 116, 118.

Similarly, whether using opposed contacts or an internal pressure switch or switches, wiring, or wiring harnesses in the form of conductors or electrically conductive thread, which may be multiple strands, may be sewn into hand wear members 24, 26, and may terminate at terminal connections 120, 122, respectively.

Terminal connections 116 and 120, or 118 and 122 may be mating pairs, and may have a male-female releasable engagement relationship. In one embodiment they may be electrically conductive snaps. In another embodiment, as seen in FIG. 7 there may be a mating plug 124 and a socket 126, in which, for example, one or other connection may be on a line, or lanyard, or lead, 125 providing a measure of slack between the respective hand-wear member and the sleeve cuff such as to facilitate connection and disconnection by the wearer. In another embodiment, the transmission may be I/R, and remote, in the manner of an electrical car-key, with the sending units in the gloves, and the receiving unit in the battery pack or micro-controller, as may be, such that sewn leads and contacts are not required.

Hand-wear members 24 and 26 may be gloves, or mittens, as may be, having a thumb portion 128 and at least one opposed finger portion 130. It may be expected that one glove or mitten is the left hand glove or mitten, and the other is the right hand glove or mitten. Each glove or mitten may have a palm portion 132, and a back of hand portion 134. The back-of-hand portion may have a tightening strap 136 such as may be cinched and held with a fabric fastener strip (of which an example is sold under the trade name “Velcro”, t.m.) in the manner of a golfing glove.

Although a glove with thumb and four fingers is shown, it may be understood that a miffing with thumb and one or two fingers may also be contemplated. In the instance shown, palm portion 132 may have a slip resistant gripping surface or treatment 138, whether rubberized or otherwise, such as may be suitable for riding a bicycle. In warmer weather embodiments, it may also be that hand-wear members 24, 26 may have open finger, or at least partially cut-off finger and thumb portions, such as might be suitable for wear in relatively warm seasons of the year.

On the inside of one or more fingers, or on the inside of the thumb, either or both of hand wear members 24, 26 may have a switch, 140, which may be a pressure sensitive switch 142. Squeezing of the thumb or finger, or fingers, such as by tightening one's grip on the handle-bars of the bicycle may tend to close switch 140. In an alternate embodiment, switch 140 may have the form of first and second contacts 144, 146 such as may be located between the thumb and side of the forefinger. Moving the thumb and forefinger together may tend to close contacts 144, 146. As with jacket 30, the wiring for switch 120 is sewn into the glove, most typically along or adjacent to a seam.

In some climates, and at some times of the year, the weather may be less than optimal for cycling. In some climates it may frequently be overcast or rainy. In some locations the hours of daylight may be short. It may be uncomfortably cold to hold the handle bars with bare hands, or to have bare hands exposed to the wind. It may, nonetheless, be desirable to indicate, for example, when one is turning, or when one is stopping. It may be desirable to be able to make such a signal without removing one's hands from the handle bars. It may also be that in colder weather, it may be helpful not to have to fumble with switches while wearing gloves or mittens, or to activate switches on a body pack.

In the embodiment illustrated, pressing the switch (or closing the opposed contacts) with the left fingers may indicate a left turn; pressing the switch (or closing the opposed contacts) with the right hand or fingers may indicate a right turn. Closing both together may indicate “Stop”. In this embodiment the operator, i.e., the cyclist, may do so without taking his or her hands of the handle bars, and may thereby be able to steer and operate the brakes while signalling. This same task may not be as easy where the cyclist has to fumble with switches that are either on the bike or on the body of the garment. Further, the cyclist may be able to do so without having to remove the gloves or mittens, as may be desirable on a less-than-warm or miserably wet day.

Whether by pressure switch 122 in the embodiment of FIG. 5, or by contact or proximity elements 124, 126 in the embodiment of FIG. 6, once switch 120 is closed or otherwise activated, controller 86 may operate to cause the various elements to illuminate. The elements 60, 62, 64, 66, 68, such as may be activated may be caused to flash in a strobe-light like manner with timed spacing between short flash discharges. In respect of the turn indicators, the flashes may proceed in a sequence such as to suggest directional motion to the “arrow” flashes. In this DC system the voltage is low, less than 24 V, the embodiment shown being 12V; and the current is very low, being of the order of a few milli-amps, with the overall power being a fraction of a Watt or a few Watts. Although the description is written in the context of cycling, the clothing apparatus may be worn while running or walking, while skiing, while on a snowmobile, or motor-bike, and so on.

That is, while the description is made in the context of a rain jacket, or rain coat, the apparatus could also be applied to active wear, or to breathable, non-waterproof material such as might be worn in an exercise context. In such an embodiment, while the fabric may not be waterproof, the other components of the jacket are waterproof, including the lights, wiring, and controller, and the battery pack is a water-sealed container.

The term “hard-wired” has been used in this description. It is used as a contrast to “wireless”. The “hard” wiring may be electrically conductive thread. Subject to detachment of the battery pack (or battery pack and controller if they are supplied in a single package), the garment is machine washable. The LEDs, wiring, and micro-controller in those embodiments are all washable.

What has been described above has been intended illustrative and non-limiting and it will be understood by persons skilled in the art that other variances and modifications may be made without departing from the scope of the disclosure as defined in the claims appended hereto. Various embodiments of the invention have been described in detail. Since changes in and or additions to the above-described best mode may be made without departing from the nature, spirit or scope of the invention, the invention is not to be limited to those details but only by the appended claims.

We claim:

1. Clothing apparatus comprising:
a body-worn member, and at least a first hand-wear member;
the body-worn member having a dorsal portion worn across the wearer's back, said dorsal portion having an illumination array;
said at least a first hand-wear member having at least a first control signal input interface;
control circuitry; and
a power source connection;
power source connection, said control circuitry, said first signal input interface and said illumination array being co-operatively mounted; and, as worn in operation,
said at least a first signal input interface of said at least a first hand-wear element being operable to control a plurality of functions of said illumination array.

2. The clothing apparatus of claim 1 wherein said power source connection is connected to a power supply chosen from the set of power supplies consisting of:
(a) a motion driven generator;
(b) a bicycle mounted battery;
(c) a pocket-carried battery pack;
(d) a ventrally mounted battery; and
(e) a dorsally mounted battery.

3. The clothing apparatus of claim 1 wherein said hand wear element is connected to said body worn element by a hard-wired connection.

4. The clothing apparatus of claim 1 wherein said body-worn element includes sleeves, and at least one of said sleeves includes circuitry by which, in use, said first hand wear element is connected to at least one of said control circuitry, said power source connection, and said illumination array.

5. The clothing apparatus of claim 1 wherein said illumination array includes at least a left turning display and a right turning display.

6. The clothing apparatus of claim 1 wherein said illuminating apparatus includes any combination of at least three of:
(a) a left turn signal display;
(b) a right turn signal display;
(c) a braking display;
(d) a body mounted running light; and
(e) an arm mounted running light.

7. The clothing apparatus of claim 1 wherein said apparatus includes said first hand-wear member and a second hand wear member, said second hand-wear member having a second control signal input interface.

8. The clothing apparatus of claim 1 wherein said body-worn member is a jacket having sleeves.

9. The clothing apparatus of claim 1 wherein said body-worn member is a rain jacket.

10. The clothing apparatus of claim 1 wherein said first hand-wear member is a glove, and said apparatus includes a second hand-wear member, said second hand-wear member being a mating glove of opposite handedness.

11. The clothing apparatus of claim 1 wherein said at least a first control signal input interface includes at least one of (a) a squeezable pressure switch; and (b) a contact switch.

12. The clothing apparatus of claim 1 wherein said illuminating array includes at least one running light.

13. The clothing apparatus of claim 1 wherein said apparatus includes a light sensor, said light sensor being operatively connected to at least a first member of said illuminating array.

14. The clothing apparatus of claim 13 wherein said illuminating array includes at least one running light and said light sensor is connected to cause said at least one running light to illuminate when dusk falls.

15. The clothing apparatus of claim 1 wherein said body-worn member includes a controller accommodation and a controller disconnect.

16. The clothing apparatus of claim 1 wherein said clothing includes said first hand wear member and a second hand-wear member, said first and second hand-wear members being first and second gloves of a pair of gloves, said first and second hand-wear members having at least first and second control signal input interfaces, said control signal input interfaces being operable to initiate a plurality of functions of said illuminating array.

17. The clothing apparatus of claim 1 wherein:
said-body worn member is a jacket having first and second sleeves, said jacket being a rain protector and having a hood;
said hand-wear includes said first hand wear member and a second hand-wear member, said first and second hand-wear members defining a pair of gloves;
said first hand-wear member having said at least a first control signal input interface;
said second hand-wear member having at least a second control signal input interface;
said gloves having cuffs for co-operation with said sleeves of said jacket; and
said gloves and said sleeves having co-operable releasable electrical connections by which said first and second control input interfaces are connected to said control circuitry.

18. The clothing apparatus of claim 1 wherein said apparatus is washable.
